(19) United States
(12) Patent Application Publication
(10) Pub. No.: US 2020/0316634 A1
(43) Pub. Date: Oct. 8, 2020

(54) SPRAY ASSEMBLY AND AGRICULTURAL PLANT PROTECTION MACHINE

(71) Applicant: SZ DJI TECHNOLOGY CO., LTD., Shenzhen (CN)

(72) Inventors: Le ZHOU, Shenzhen (CN); Chuoying LU, Shenzhen (CN); Xiaolong WU, Shenzhen (CN)

(21) Appl. No.: 16/903,812

(22) Filed: Jun. 17, 2020

Related U.S. Application Data
(63) Continuation of application No. PCT/CN2017/116908, filed on Dec. 18, 2017.

(51) Int. Cl. B05B 15/652; A01M 7/00; B64C 39/02; B64D 1/18

(52) U.S. Cl. CPC B05B 15/652; A01M 7/0042; B64C 2201/12; B64D 1/18; B64C 2201/027; B64C 39/024

(57) ABSTRACT

A spray assembly includes a spray bar, a spray head assembly, and a connection base. The spray head assembly is connected to an end of the spray bar. The connection base is connected to another end of the spray bar and configured to fix the spray bar at a frame of an agricultural plant protection machine. The connection base includes a flexible connection base. The connection base is configured to cause the spray bar to swing relative to the frame in response to the spray bar being subjected to an external force.

### CROSS-REFERENCE TO RELATED APPLICATION

This application is a continuation of International Application No. PCT/CN2017/116908, filed Dec. 18, 2017, the entire content of which is incorporated herein by reference.

### TECHNICAL FIELD

The present disclosure relates to the spray system technology field and, more particularly, to a spray assembly and an agricultural plant protection machine.

### BACKGROUND

In related technology, a spray system is used to spray liquids of pesticides, fertilizers, water, etc., in agricultural production and plant protection. A spray assembly mounted at an agricultural plant protection machine is configured to spray the liquids to surfaces of crops. As such, the agricultural plant protection machine can release working labor and improve an operation efficiency.

A spray bar of the spray assembly of the existing agricultural plant protection machine is rigidly connected to a frame of the agricultural plant protection machine. The spray bar generally extends longer relative to a body of the agricultural plant protection machine. Thus, the spray bar is easy to break during transportation and collision.

### SUMMARY

Embodiments of the present disclosure provide a spray assembly, including a spray bar, a spray head assembly, and a connection base. The spray head assembly is connected to an end of the spray bar. The connection base is connected to another end of the spray bar and configured to fix the spray bar at a frame of an agricultural plant protection machine. The connection base includes a flexible connection base. The connection base is configured to cause the spray bar to swing relative to the frame in response to the spray bar being subjected to an external force.

Embodiments of the present disclosure provide a spray assembly including a spray bar, a spray head assembly, and a connection base. The spray head assembly is connected to an end of the spray bar. The connection base is connected to another end of the spray bar and configured to fix the spray bar to a frame of an agricultural plant protection machine. The spray bar includes a first bar body, a second bar body, and a flexible connector. The second bar body is connected to a spray head assembly. The flexible connector connects the first bar body and the second bar body, and is configured to cause the second bar body to swing relative to the first bar body in response to the second bar body being subjected to an external force.

### BRIEF DESCRIPTION OF THE DRAWINGS

FIG. 1 illustrates a schematic structural diagram of a spray assembly according to some embodiments of the present disclosure.

FIG. 2 illustrates a schematic exploded view of the spray assembly according to some embodiments of the present disclosure.

FIG. 3 illustrates a schematic structural diagram of a connection base of the spray assembly according to some embodiments of the present disclosure.

FIG. 4 illustrates a schematic assembly diagram of the connection base and a spray bar according to some embodiments of the present disclosure.

FIG. 5 illustrates a schematic assembly diagram of the connection base and the spray bar according to some other embodiments of the present disclosure.

FIG. 6 illustrates a schematic assembly diagram of the connection base and the spray bar according to some other embodiments of the present disclosure.

FIG. 7 illustrates a schematic assembly diagram of the connection base and the spray bar according to some other embodiments of the present disclosure.

FIG. 8 illustrates a schematic assembly diagram of the spray bar and a spray head assembly according to some other embodiments of the present disclosure.

FIG. 9 illustrates a schematic structural diagram of a spray assembly according to some other embodiments of the present disclosure.

FIG. 10 illustrates a schematic structural diagram of an agricultural plant protection machine according to some embodiments of the present disclosure.

### DETAILED DESCRIPTION OF THE EMBODIMENTS

The technical solutions are described clearly in conjunction with accompanying drawings in embodiments of the present disclosure. The described embodiments are only some embodiments not all the embodiments of the present disclosure. Based on described embodiments of the disclosure, all other embodiments obtained by those of ordinary skill in the art without any creative work are within the scope of the present disclosure.

Exemplary embodiments are described in detail here. Examples of exemplary embodiments are shown in the accompanying drawings. In the following description associated with the accompanying drawings, unless otherwise indicated, same numerals in different drawings represent same or similar elements. Implementations described in following exemplary embodiments do not represent all embodiments consistent with the present disclosure. Rather, they are merely examples of devices and methods consistent with some aspects of the disclosure.

The terms used in the present disclosure are only for purposes of describing specific embodiments, and do not intend to limit the present disclosure. The singular forms “a,” “said,” and “the” used in the present disclosure and the appended claims also intend to include plural forms unless the context clearly indicates other meanings. The term “and/or” as used herein refers to and includes any or all possible combinations of one or more associated listed items.

A spray assembly and an agricultural plant protection machine of the present disclosure are described in detail below in conjunction with the accompanying drawings. In the case of no conflict, features in following examples and implementations can be combined with each other.

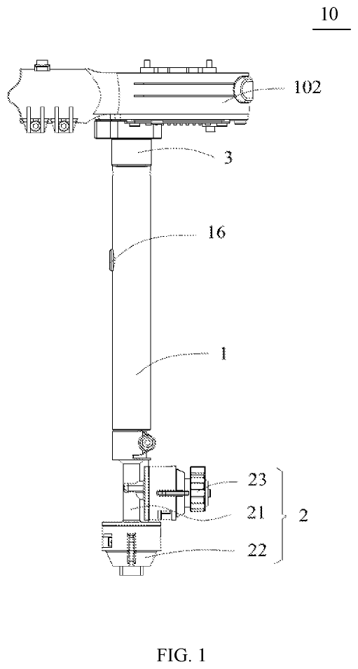

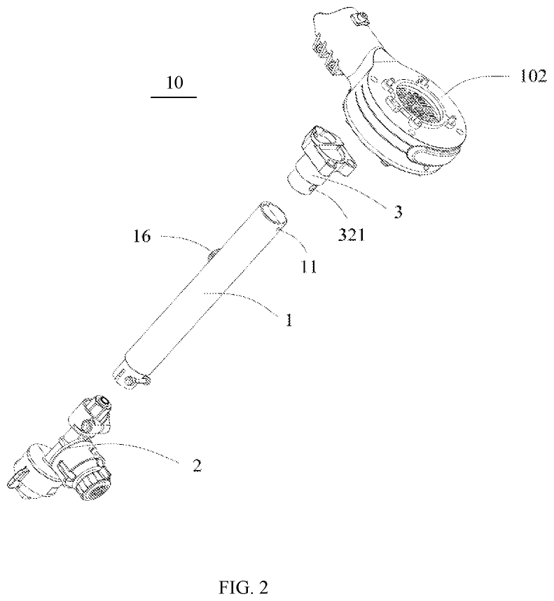

FIG. 1 and FIG. 2 show a spray assembly 10 consistent with embodiments of the present disclosure. The spray assembly 10 includes a spray bar 1, a spray head assembly 2, and a connection base 3. The spray head assembly 2 is connected to an end of the spray bar 1. The connection base 3 is connected to the other end of the spray bar 1. The connection base 3 is configured to fix the spray bar 1 to a frame of the agricultural plant protection machine. The agricultural plant protection machine sprays liquids of pesticides, fertilizers, water, etc., through the spray bar 1.

The connection base 3 of the present disclosure is a flexible connection base 3, which can cause the spray bar 1 to be able to swing relative to the frame when the spray bar 1 is subjected to an external force. In some embodiments, when the spray bar 1 is subjected to the external force, the spray bar 1 can swing for a certain amplitude or bend by using the flexible connection base 3 as a reference point. As such, when the spray assembly 10 bumps into something during transportation of the agricultural plant protection machine, the spray bar 1 will not be broken.

The connection base 3 can be made of rubber material. In some embodiments, the connection base 3 is made of one or more of nitrile butadiene rubber (NBR), ethylene propylene diene monomer (EPDM), and fluororubber (FPM). The material of the connection base 3 of the present disclosure is not limited to the above-described rubber materials. Materials having flexibility and elasticity may all be suitable for the connection base 3 of the present disclosure.

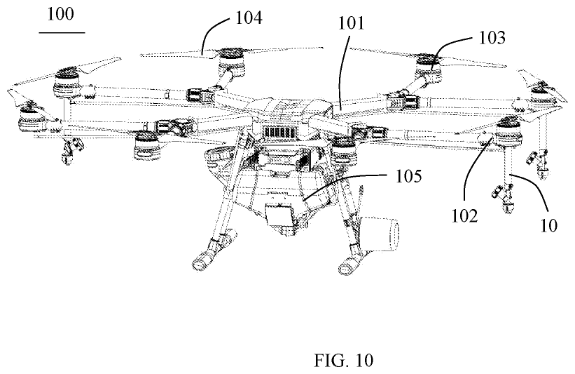

As shown in FIG. 1 and FIG. 10, in embodiments of the present disclosure, the spray assembly 10 is fixed under an arm 102 of an agricultural plant protection machine 100 through the connection base 3. A power device 103 is arranged at the arm 102, and a rotor 104 is arranged at the power device 103. When the power device 103 drives the rotor 104 to rotate, the rotor 104 creates a downward air flow. The air flow can assist and cause water mist sprayed by the spray head assembly 2 to agricultural crops and reduce an impact of a wind direction.

As shown in FIG. 3, the connection base 3 includes a base body 31 and a connector 32 extending from the base body 31. In some embodiments, assembly holes 311 is arranged at the base body 31. The connection base 3 is fixed at the frame by cooperating the assembly holes 311 with connection members. In some embodiments, the connection members may be screws or rivets. As such, the connection base 3 is detachably mounted at the frame of the agricultural plant protection machine, which is convenient for disassembly and transportation of the agricultural plant protection machine. In some other embodiments, the base body 31 may be fixed at the frame through an adhesive layer, or the connection base 3 and the arm may be integrally formed.

The connection base 3 of the present disclosure is fixed at the spray bar 1 through the connector 32. Example fixing and connecting manners are described below.

In some embodiments, as shown in FIG. 2, a lock hole 321 is arranged at the connector 32, and a connection hole 11 is arranged at the spray bar 1. When the connector 32 is mounted inside the spray bar 1, the lock hole 321 is aligned with the connection hole 11, which are locked by a connection member. In some embodiments, the connector 32 is inserted in the spray bar 1. The size of the connector 32 is set to limit the size of the portion of the connection base 3 that is inserted in the spray bar 1. When the connector 32 reaches an assembly position, the lock hole 321 can be aligned with the connection hole 11. If not aligned, the spray bar 1 can be rotated to align the lock hole 321 with the connecting hole 11. Then, the connector 32 is fixed to the spray bar 1 by the connection member, which may be a screw or a bolt. In other embodiments, the spray bar 1 may be inserted in the connector 32.

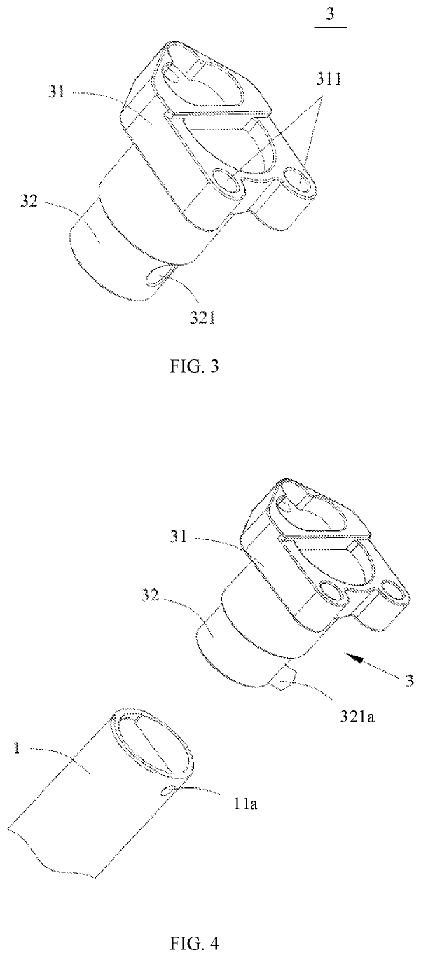

In some embodiments, as shown in FIG. 4, a spring pin 321a is arranged at the connector 32. When the spring pin 321a is subjected to an external force, the spring pin 321a can be compressed to be in the connector 32. After the external force is lifted, the connector 32 can be ejected by an elastic force. Correspondingly, a connection hole 11a is arranged at the spray bar 1. When the connector 32 is mounted to the spray bar 1, under the external force (including pressing the spring pin 321a or the spring pin 321a abutting against the inner wall of the spray bar 1), the spring pin 321a is retracted to be in the connector 32. When the spring pin 321a is aligned with the connection hole 11a, the spring pin 321a protrudes from the connection hole 11a by the elastic force, such that the connection base 3 is locked at the spray bar 1.

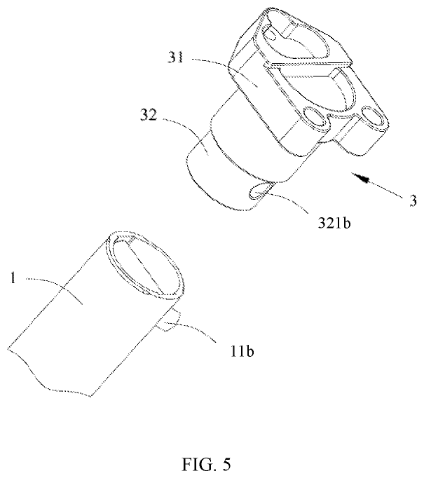

In some embodiments, as shown in FIG. 5, a connection hole 321b is arranged at the connector 32. A spring pin 11b is arranged at the spray bar 1. In some embodiments, a part where the spray bar 1 is connected to the connector 32 is mounted inside the connector 32. When the connector 32 is mounted to the spray bar 1, under the external force (including pressing the spring pin 11b or the spring pin 11b abutting against the inner wall of the connector 32), the spring pin 11b is retracted in the spray bar 1. When the spring pin 11b is aligned with the connection hole 321b, the spring pin 11b protrudes from the connection hole 321b by an elastic force, such that the connection based 3 is locked at the spray bar 1.

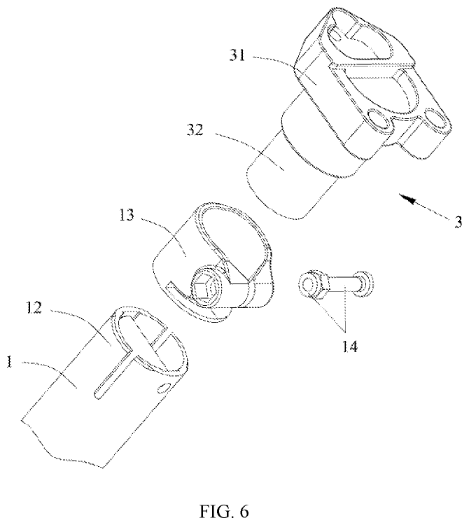

In some embodiments, as shown in FIG. 6, the spray bar 1 includes a plurality of elastic lock pieces 12 configured to cooperate to wrap the connector 32, a lock ring 13 surrounding the elastic lock pieces 12, and a bolt 14 configured to lock or release the lock ring 13. In some embodiments, the plurality of elastic lock pieces 12 cooperate and surround to form a circle. The connector 32 is mounted among the plurality of elastic lock pieces 12 of the spray bar 1. When the bolt 14 is locked, the plurality of elastic lock pieces 12 can clamp the connector 32, such that the connection base 3 and the spray bar 1 are fixed together.

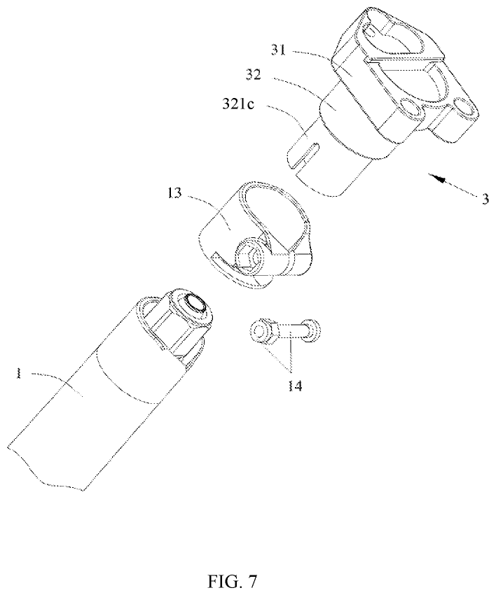

In some embodiments, as shown in FIG. 7, the connector 32 includes a plurality of elastic lock pieces 321c configured to cooperate to wrap the spray bar 1, a lock ring 13 surrounding the elastic lock pieces 321c, and a bolt 14 configured to lock or release the lock ring 13. In some embodiments, the connector 32 includes the plurality of elastic lock pieces 321c. The plurality of elastic lock pieces 321c cooperate to form a circle. The spray bar 1 is mounted among the plurality of elastic lock pieces 321c of the connector 32. When the bolt 14 is locked, the plurality of elastic lock pieces 321c can clamp the spray bar 1, such that the connection base 3 and the spray bar 1 are fixed together.

In some embodiments, the connector 32 may also be fixed at the spray bar 1 through an adhesive layer (e.g., adhesive). In some embodiments, the flexible connection base 3 and the spray bar 1 are integrally formed when the flexible connection base 3 and the spray bar 1 are made.

Manners for fixing the connection base 3 at the spray bar 1 are not limited to the above-described embodiments. Any cooperation manners that can fix the connection base 3 at the spray bar 1 are all suitable for the present disclosure.

Further, as shown in FIG. 1, FIG. 2, and FIG. 10, a water inlet (not shown) is arranged at the spray bar 1, and a mounting member 16 is arranged at the water inlet. The mounting member 16 is configured to mount a connection water pipe (not shown) connecting to a water tank 105 of the agricultural plant protection machine 100. In some embodiments, the mounting member 16 includes a threaded ring arranged on a periphery of the water inlet. A screw cap is arranged at the connection water pipe, which cooperates with the mounting member 16 for a screw connection. With the connection of the screw cap to the mounting member 16, the spray bar 1 is connected to the water tank 105 through the connection water pipe. As such, water can flow from the water tank 105 to the spray bar 1. The mounting member 16 of the present disclosure is not limited to the screw ring. Cooperation structures that can mount the connection water pipe to the spray bar 1 may all be suitable for the spray assembly 10 of the present disclosure.

A water flow channel (not shown) is arranged in the spray bar 1 and connected between the water inlet and the spray head assembly 2. The water flow channel guides the water flow in the spray bar 1 to the spray head assembly 2. At least the part of the spray bar 1 between the water inlet and the spray head assembly 2 is hollow to form the water flow channel. In some embodiments, a pipe channel is arranged in the hollow part of the spray bar 1 to connect the connection water pipe and the spray head assembly 2.

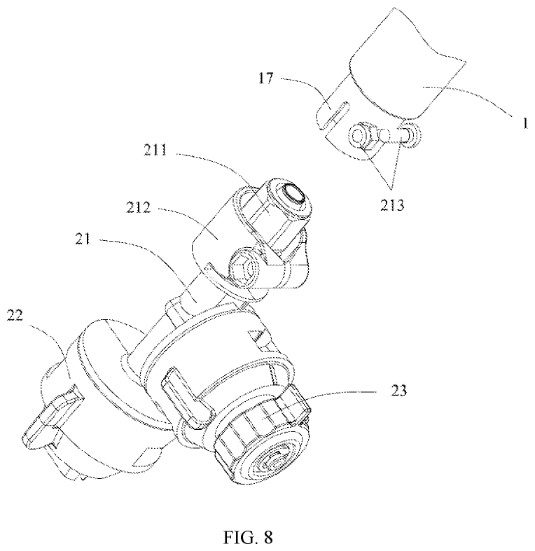

As shown in FIG. 1 and FIG. 8, the spray head assembly 2 includes a spray head body 21, a nozzle 22 arranged at the spray head body 21, and a pressure release adjustment member 23 mounted at the spray head body 21. The pressure release adjustment member 23 is configured to adjust a water spray volume of the nozzle 22. The pressure release adjustment member 23 is further configured to open or close the nozzle 22.

In some embodiments, a cooperation member 211, a lock ring 212 surrounding the cooperation member 211, and a bolt 213 for cooperating with the lock ring 212 are arranged at the spray head body. At least two elastic lock pieces 17 are arranged at the spray bar 1 and configured to cooperate to wrap the cooperation member 211. When the elastic lock pieces 17 are mounted between the cooperation member 211 and the lock ring 212, the spray head body 21 is fixed at the spray bar 1 through tightening the locking bolt 213. When the bolt 213 is released, the spray head body 21 is dismounted from the spray bar 1. Manners of connecting the spray head assembly and the spray bar 1 are not limited here. Any of the manners of connecting the spray bar 1 and the connection base 3 described above may be implemented for the connection between the spray head assembly 2 and the spray bar 1, which are not repeated here.

As shown in FIG. 1 and FIG. 10, embodiments of the present disclosure further provide the agricultural plant protection machine 100. The agricultural plant protection machine 100 includes a frame 101 and the spray assembly 10 mounted at the frame 101. The spray assembly 10 includes the spray bar 1, the spray head assembly 2, and the connection base 3. The spray head assembly 2 is connected to an end of the spray bar 1. The connection base 3 is connected to the other end of the spray bar 1 and configured to fix the spray bar 1 at the frame 101. The connection base 3 can be a flexible connection base 3. When the spray bar 1 is subjected to an external force, the connection base 3 can cause the spray bar 1 to swing relative to the frame 101. For specific structural features of cooperation among components of the spray assembly 10, reference can be made to the above embodiments of the spray assembly 10, which are not repeated here.

According to the present disclosure, a spray assembly with a new structure and an agricultural plant protection machine having the spray assembly are provided. The connection base connecting the spray bar 1 and the frame can include a flexible connection base, such that the spray assembly has a certain flexibility. When the spray bar is subjected to an external force, the spray bar can swing relative to the frame and does not break, which extends service lifetime of the spray assembly.

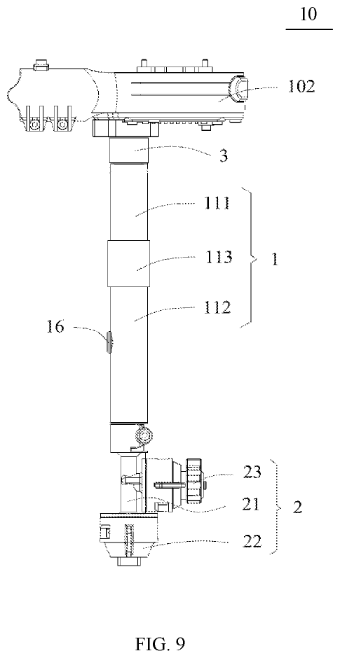

FIG. 9 shows another example of the spray assembly 10 consistent with embodiments of the disclosure. As shown in FIG. 9, the spray assembly 10 includes the spray bar 1, the spray head assembly 2, and the connection base 3. The spray head assembly 2 is connected to an end of the spray bar 1. The connection base 3 is connected to the other end of the spray bar 1 and configured to fix the spray bar 1 at the frame of the agricultural plant protection machine. The agricultural plant protection machine spray liquids of pesticides, fertilizers, water, etc., through the spray bar 1.

The spray bar 1 includes a first bar body 111, a second bar body 112, and a flexible connector 113 connecting the first bar body 111 and the second bar body 112. The second bar body 112 is connected to the spray head assembly 2. The flexible connector 113 causes the second bar body 112 to swing relative to the first bar body 111, when the second bar body 112 is subjected to an external force. In some embodiments, when the spray bar 1 is subjected to the external force, the spray bar 1 can swing for a certain amplitude or bend by using the flexible connection 113 as a reference point. As such, when the spray assembly 10 bumps into something during the transportation of the agricultural plant protection machine, the spray bar 1 does not break.

The connector 113 can be made of rubber material. In some embodiments, the connector 113 is made of one or more of nitrile butadiene rubber (NBR), ethylene propylene diene monomer (EPDM), and fluororubber (FPM). The material of the connector 113 of the present disclosure is not limited to the above-described rubber materials. Materials having flexibility and elasticity may all be suitable for the connection base 3 of the present disclosure.

In embodiments of the present disclosure, the spray assembly 10 is fixed under an arm of the agricultural plant protection machine. A power device is arranged at the arm, and a rotor is arranged at the power device. When the power device drives the rotor to rotate, the rotor creates a downward air flow. The air flow can assist and cause water mist sprayed by the spray head assembly 2 to agricultural crops and reduce an impact of a wind direction.

In some embodiments, an assembly hole is arranged at the base body. The connection base 3 is fixed at the frame by cooperating a connection member with the assembly hole. In some embodiments, the connection member may be a screw or a rivet. As such, the connection base 3 is detachably mounted at the frame of the agricultural plant protection machine, which is convenient for disassembly and transportation of the agricultural plant protection machine. In some other embodiments, the base body 31 may be fixed at the frame through an adhesive layer, or the connection base 3 and the arm may be integrally formed.

The connection base 3 may include a flexible connection base 3 and also be a rigid connection base 3. For a manner of connecting the connection base 3 and the first bar body 111, reference can be made to a plurality of connection embodiments of the flexible connector 113 with the first bar body 111 and the second bar body 112.

The first bar body 111 of the present disclosure is fixed at the second bar body 112 through the flexible connector 113. Specific implementations are described below.

In some embodiments, lock holes are arranged at the flexible connector 113. Connection holes are arranged at the first bar body 111 and the second bar body 112, respectively. When the flexible connector 113 is mounted at the first bar body 111 and the second bar body 112, the lock holes are aligned with the connection holes. As such, connection members cooperate to lock the lock holes and the connection holes.

In some embodiments, two ends of the flexible connector 113 are inserted in the first bar body 111 and the second bar body 112, respectively, or the first bar body 111 and the second bar body 112 are inserted in the flexible connector 113. By limiting sizes of insertions, after the flexible connector 113, the first bar body 111, and the second bar body 112 reaches assembly positions, the lock holes are aligned with the connection holes. If not aligned, the flexible connector 113 can be rotated to align the lock holes with the connection holes. The first bar body 111 is then fixed at the flexible connector 113, and the second bar body 112 is fixed at the flexible connector 113 through the connection members. The connection members may include screws or bolts.

In some embodiments, spring pins are arranged at the two ends of the flexible connector 113, respectively. The connection holes are arranged at the first bar body 111 and the second bar body 112, respectively. When the flexible connector 113 is mounted at the first bar body 111 and the second bar body 112, the spring pins are retracted in the flexible connector 113. When the spring pins are aligned with the connection holes, the spring pins protrude from the connection holes by elastic forces. As such, the flexible connector 113 is locked at the first bar body 111 and the second bar body 112.

In some embodiments, when the flexible connector 113 is mounted at the first bar body 111 and the second bar body 112, the spring pin of the flexible connector 113 cooperating with the first bar body 111 is retracted in the flexible connector 113, when the spring pin abuts against an inner wall of the first bar body 111. When the spring pin is aligned with the connection hole at the first bar body 111, the spring pin protrudes from the connection hole by the elastic force, such that the flexible connector 113 is fixed at the first bar body 111. The spring pin of the flexible connector 113 cooperating with the second bar body 112 is retracted in the flexible connector 113, when the spring pin abuts against an inner wall of the second bar body 112. When the spring pin is aligned with the connection hole at the second bar body 112, the spring pin protrudes from the connection hole by the elastic force, such that the flexible connector 113 is fixed at the second bar body 112.

In some embodiments, the connection holes are arranged at the two ends of the flexible connector 113, respectively. The spring pins are arranged at the first bar body 111 and the second bar body 112, respectively. When the flexible connector 113 is mounted at the first bar body 111 and the second bar body 112, the spring pin of the first bar body 111 is retracted in the first bar body 111, and the spring pin of the second bar body 112 is retracted in the second bar body 112. When the spring pin of the first bar body 111 is aligned with the connection hole that cooperates with the spring pin, the spring pin protrudes from the connection hole by the elastic force. As such, the flexible connector 113 is locked at the first bar body 111. When the spring pin of the second bar body 112 is aligned with the connection hole that cooperates with the spring pin, the spring pin protrudes from the connection hole by the elastic force. As such, the flexible connector 113 is locked at the second bar body 112.

In some embodiments, a connection hole is arranged at an end of the flexible connector, and a spring pin is arranged at the other end of the flexible connector. The connection holes and the spring pins can be arranged according to customer needs. Specific mounting manners are the same as the above-described embodiments, which are not repeated here.

In some embodiments, the first bar body 111 and the second bar body 112 include a plurality of elastic lock pieces configured to cooperate to wrap the flexible connector, lock rings for surrounding the elastic lock pieces, and bolts configured to lock or release the lock ring. In some embodiments, the plurality of elastic lock pieces cooperate to form a circle. The two ends of the flexible connector 113 are mounted among the plurality of elastic lock pieces of the first bar body 111 and the plurality of elastic lock pieces of the second bar body 112, respectively. By locking the bolts, the plurality of elastic lock pieces clamp the flexible connector 113. As such, the flexible connector 113 is fixed at the first bar body 111 and the second bar body 112.

In some embodiments, cooperation structures of the elastic lock pieces, lock rings, and bolts may be arranged at both ends of the flexible connector 113. The cooperation structures are configured to clamp the first bar body 111 and the second bar body 112. As such, the flexible connector 113 is fixed at the first bar body 111 and the second bar body 112.

In some embodiments, the flexible connector 113 is fixed at the first bar body 111 and the second bar body 112 through adhesive layers (e.g., adhesives). In some embodiments, the flexible connector 113 is integrally formed with the first bar body 111 and the second bar body 112 when the flexible connector 3, the first bar body 111, and the second bar body 112 are made.

In the present disclosure, manners for fixing the flexible connector 113 at the first bar body 111 and the second bar body 112 are not limited by above-described embodiments. Cooperation manners that can fix the flexible connector 113 at the first bar body 111 and the second bar body 112 are all suitable for the present disclosure.

Further, a water inlet is arranged at the spray bar 1, and a mounting member 16 is arranged at the water inlet. The mounting member 16 is configured to mount a connection water pipe connecting to a water tank of the agricultural plant protection machine. In some embodiments, the mounting member 16 includes a threaded ring arranged on a periphery of the water inlet. A screw cap is arranged at the connection water pipe, which cooperates with the mounting member 16 for a screw connection. With the connection of the screw cap to the mounting member 16, the spray bar 1 is connected to the water tank 105 through the connection water pipe. As such, water can flow from the water tank 105 to the spray bar 1. The mounting member 16 of the present disclosure is not limited to the screw ring. Cooperation structures that can mount the connection water pipe to the spray bar 1 may all be suitable for the spray assembly 10 of the present disclosure.

A water flow channel is arranged in the spray bar 1 and connected between the water inlet and the spray head assembly 2. The water flow channel guides the water flow in the spray bar 1 to the spray head assembly 2. At least the part of the spray bar 1 between the water inlet and the spray head assembly 2 is hollow to form the water flow channel. In some embodiments, a pipe channel is arranged in the hollow part of the designed spray bar 1 to connect the connection water pipe and the spray head assembly 2.

The spray head assembly 2 of the present disclosure includes a spray head body 21, a nozzle 22 arranged at the spray head body 21, and a pressure release adjustment member 23 mounted at the spray head body 21. The pressure release adjustment member 23 is configured to adjust a water spray volume of the nozzle 22. The pressure release adjustment member 23 is further configured to open or close the nozzle 22.

In some embodiments, a cooperation member, a lock ring surrounding the cooperation member, and a bolt for cooperating with the lock ring are arranged at the spray head body. At least two elastic lock pieces are arranged at the spray bar 1 and configured to cooperate to wrap the cooperation member. When the elastic lock pieces are mounted between the cooperation member and the lock ring, the spray head body is fixed at the spray bar 1 through tightening the locking bolt. When the bolt is released, the spray head body is dismounted from the spray bar 1. Manners of connecting the spray head assembly 2 and the spray bar 1 are not limited here. Any of the manners of connecting the first bar body 111 and the second bar body 112 to the flexible connector 113 described above may be implemented for the connection between the spray head assembly 2 and the spray bar 1, which are not repeated here.

Embodiments of the present disclosure further provides an agricultural plant protection machine. The agricultural plant protection machine includes a frame and a spray assembly mounted at the frame. The spray assembly includes a spray bar, a spray head assembly, and a connection base. The spray head assembly is connected to an end of the spray bar. The connection base is connected to the other end of the spray bar and configured to fix the spray bar at the frame. The spray bar includes a first bar body, a second bar body, and a flexible connector for connecting the first bar body and the second bar body. The second bar body is connected to the spray head assembly. The flexible connector can cause the second bar body to swing relative to the first bar body, when the second bar body is subjected to an external force. For specific structure features of cooperation among components of the spray assembly, reference can be made to various embodiments of the above-described spray assembly, which are not repeated here.

According to the present disclosure, a spray assembly with a new structure and an agricultural plant protection machine having the spray assembly are provided. The spray bar connected to the frame includes a first bar body, a second bar body, and a flexible connector connecting the first bar body and the second bar body, such that the whole spray bar has a certain flexibility. When the spray bar is subjected to an external force, the second bar body can swing relative to the first bar body and does not break, which extends the service lifetime of the spray assembly.

In the present specification, relational terms such as first and second are only used to distinguish one entity or operation from another entity or operation, and do not necessarily require or imply any such actual relationship or order between these entities or operations. The terms “include,” “contain,” or any other variations thereof intent to cover non-exclusive inclusion, so that a process, method, article, or device that includes a series of elements includes not only those elements, but also other elements that are not explicitly listed, or also include elements inherent to such process, method, article, or device. Without additional restrictions, the element associated with a clause “including one . . . ” does not exclude existence of other identical element in the process, method, article, or device that includes the element.

The methods and devices provided by embodiments of the present disclosure are described in detail above. The specific examples are used to explain the principles and implementations of the present disclosure. The description of the above embodiments is only used to help to understand the methods and core ideas of the present disclosure. For those of ordinary skill in the art, according to the idea of the present disclosure, changes may be made to the specific implementations and application scope. In summary, the content of this specification should not be understood as a limitation to the present disclosure.

What is claimed is:

1. A spray assembly comprising:
a spray bar;
a spray head assembly connected to an end of the spray bar; and
a connection base connected to another end of the spray bar and configured to fix the spray bar to a frame of an agricultural plant protection machine, the connection base including a flexible connection base configured to cause the spray bar to swing relative to the frame in response to the spray bar being subjected to an external force.

2. The spray assembly of claim 1, wherein the connection base includes:
a base body; and
a connector extending from the base body and configured to fix the connection base at the spray bar.

3. The spray assembly of claim 2, further comprising:
a connection member;
wherein:
the connector includes a lock hole;
the spray bar includes a connection hole configured to be aligned with the lock hole; and
the connection member is configured to be inserted through the lock hole and the connection hole to connect the connector to the spray bar lock hole.

4. The spray assembly of claim 2, wherein:
the spray bar includes a connection hole; and
the connector includes a spring pin configured to:
be retracted in the connector during a process of mounting the connector to the spray bar when the spring pin is not aligned with the connection hole; and
protrude from the connection hole by an elastic force to fix the connection base at the spray bar when the spring pin is aligned with the connection hole.

5. The spray assembly of claim 2, wherein:
the connector includes a connection hole; and
the spray bar includes a spring pin configured to:
be retracted in the spray bar during a process of mounting the connector to the spray bar when the spring pin is not aligned with the connection hole; and
protrude from the connection hole by an elastic force to fix the connection base at the spray bar when the spring pin is aligned with the connection hole.

6. The spray assembly of claim 2, wherein the spray bar includes:
a plurality of elastic lock pieces configured to cooperate to wrap the connector;
a lock ring configured to surround the elastic lock pieces; and
a bolt configured to lock or release the lock ring.

7. The spray assembly of claim 2, wherein the connector includes:
a plurality of elastic lock pieces configured to cooperate to wrap the connector;
lock rings configured to surround the elastic lock pieces; and
a bolt configured to lock or release the lock ring

8. The spray assembly of claim 2, wherein the connector is fixed at the spray bar through an adhesive layer.

9. The spray assembly of claim 2, further comprising:
a connection member;
wherein:
the base body includes an assembly hole; and
the connection member is configured to cooperate with the assembly hole to fix the connection base to the frame.

10. The spray assembly of claim 2, wherein the base body is fixed at the frame through an adhesive layer.

11. The spray assembly of claim 1, wherein the spray assembly is configured to be fixed under an arm of the agricultural plant protection machine through the connection base.

12. The spray assembly of claim 1, wherein the connection base is made of one or more of nitrile butadiene rubber (NBR), ethylene propylene diene monomer (EPDM), and fluororubber (FPM).

13. The spray assembly of claim 1, wherein the spray bar includes:
a water inlet; and
a mounting member arranged at the water inlet and configured to mount a connection water pipe connecting to a water tank of the agricultural plant protection machine.

14. The spray assembly of claim 13, wherein a water flow channel connecting the water inlet and the spray head assembly is arranged in the spray bar.

15. The spray assembly of claim 1, wherein the spray head assembly includes:
a spray head body;
a nozzle arranged at the spray head body; and
a pressure release adjustment member mounted at the spray head body and configured to adjust a water spray volume of the nozzle.

16. The spray assembly of claim 15, wherein:
the spray head body includes a cooperation member, a lock ring surrounding the cooperation member, and a bolt cooperating with the lock ring;
the spray bar includes at least two elastic lock pieces configured to cooperate to:
wrap the cooperation member to fix the spray head body at the spray bar through the locking bolt, or
allow the spray head body to be dismounted from the spray bar in response to the bolt being released.

17. A spray assembly comprising:
a spray bar;
a spray head assembly connected to one end of the spray bar; and
a connection base connected to another end of the spray bar and configured to fix the spray bar to a frame of an agricultural plant protection machine;
wherein the spray bar includes:
a first bar body;
a second bar body connected to a spray head assembly; and
a flexible connector connecting the first bar body and the second bar body, configured to cause the second bar body to swing relative to the first bar body in response to the second bar body being subjected to an external force.
